(19) United States
(12) Patent Application Publication
(10) Pub. No.: US 2025/0162644 A1
(43) Pub. Date: May 22, 2025

(54) STEERING RACK ASSEMBLY AND ELECTRIC POWER STEERING SYSTEM INCLUDING THE SAME

(71) Applicant: Chieh-Chi CHEN, New Taipei City (TW)

(72) Inventor: Chieh-Chi CHEN, New Taipei City (TW)

(21) Appl. No.: 18/938,485

(22) Filed: Nov. 6, 2024

(30) Foreign Application Priority Data
Nov. 20, 2023 (TW) 112144810

(51) Int. Cl. B62D 5/04

(52) U.S. Cl. CPC B62D 5/0445

(57) ABSTRACT

A steering rack assembly includes a first rod member, a second rod member and a securing sleeve. The first rod member includes a first terminal portion formed with a recess. The recess has a first internal thread. The second rod member includes a second terminal portion inserted into the recess of the first rod member. The second terminal portion has a first external thread engaging the first internal thread. One of the first rod member and the second rod member is a screw device and the other is a rack. The securing sleeve is fixedly fit over the first terminal portion of the first rod member and the second rod member.

### RELATED APPLICATIONS

This application claims priority to Taiwan Application Serial Number 112144810, filed Nov. 20, 2023, the disclosure of which is incorporated herein by reference in its entirety.

### BACKGROUND

### Technical Field

The present disclosure relates to a steering rack assembly and an electric power steering system including the same.

### Description of Related Art

Steering rack is an important component in vehicle steering systems. Due to safety concerns, steering racks are conventionally designed to be unitary. Since there is no public standard for steering racks, a steering rack designer or vendor working with multiple vehicle manufacturers must design and develop the entire steering rack independently for each vehicle manufacturer to meet the different requirements of different vehicle manufacturers.

### SUMMARY

In view of the foregoing, one of the objects of the present disclosure is to provide a steering rack assembly that can resolve the problem mentioned above.

In accordance with an embodiment of the present disclosure, a steering rack assembly includes a first rod member, a second rod member and a securing sleeve. The first rod member includes a first terminal portion formed with a recess. The recess has a first internal thread. The second rod member includes a second terminal portion inserted into the recess of the first rod member. The second terminal portion has a first external thread engaging the first internal thread. One of the first rod member and the second rod member is a screw device and the other is a rack. The securing sleeve is fixedly fit over the first terminal portion of the first rod member and the second rod member.

In one or more embodiments of the present disclosure, the first terminal portion of the first rod member has a second external thread surrounding the recess. The securing sleeve has a second internal thread engaging the second external thread. The securing sleeve is fixedly joined with the second rod member via a joint structure.

In one or more embodiments of the present disclosure, the joint structure includes a solder or welding joint. The solder or welding joint is arranged along an end surface of the securing sleeve and is fixedly attached to the end surface of the securing sleeve and an outer surface of the second rod member.

In one or more embodiments of the present disclosure, the recess of the first rod member has a threaded section and a non-threaded section. The threaded section has the first internal thread. The non-threaded section is located between the threaded section and an entrance of the recess. The non-threaded section has a greater inner diameter than the threaded section.

In one or more embodiments of the present disclosure, the second terminal portion of the second rod member has a first section and a second section. The first section has the first external thread. The second section is inserted into the non-threaded section of the recess. The second section has a greater outer diameter than the first section.

In one or more embodiments of the present disclosure, the securing sleeve has a smooth inner circumferential surface that is in tight contact with the first terminal portion of the first rod member and the second rod member. The securing sleeve is fixedly joined with the first rod member and the second rod member via at least one joint structure.

In one or more embodiments of the present disclosure, the securing sleeve has two opposite end surfaces. The joint structure includes at least one solder or welding joint. The solder or welding joint is arranged along the two opposite end surfaces of the securing sleeve and is fixedly attached to the two opposite end surfaces of the securing sleeve, an outer surface of the first rod member, and an outer surface of the second rod member.

In one or more embodiments of the present disclosure, the first rod member and the second rod member include a first stopper structure and a second stopper structure, respectively. The securing sleeve is clamped between the first stopper structure and the second stopper structure.

In one or more embodiments of the present disclosure, the first rod member further includes a first main body connected to the first terminal portion. The first terminal portion has a smaller outer diameter than the first main body and thereby creates a first stepped structure that acts as the first stopper structure. The second rod member further includes a second main body with two sections. The two sections have different outer diameters and thereby create a second stepped structure that acts as the second stopper structure.

In one or more embodiments of the present disclosure, the screw device is a ball screw.

In accordance with an embodiment of the present disclosure, an electric power steering system includes the steering rack assembly described above and an electric motor. The electric motor is mechanically coupled to the screw device of the steering rack assembly and is configured to linearly move the steering rack assembly.

In sum, the steering rack assembly of the present disclosure includes a first rod member and a second rod member interconnected via internal and external threads, and further includes a securing sleeve fixedly fit over the first rod member and the second rod member and covering the connection interface between the first rod member and the second rod member. The securing sleeve can not only facilitate affixing the first rod member and the second rod member to each other, but also improve the mechanical strength of the connection interface between the first rod member and the second rod member to prevent rupture of the steering rack assembly. Furthermore, the securing sleeve can be fixedly joined with the first rod member and/or the second rod member additionally via a joint structure (e.g., solder/welding joint, pin joint, mortise and tenon joint, or other suitable joint structures), such that the first rod member, the second rod member and the securing sleeve can be more tightly combined.

### BRIEF DESCRIPTION OF THE DRAWINGS

To make the objectives, features, advantages, and embodiments of the present disclosure, including those mentioned above and others, more comprehensible, descriptions of the accompanying drawings are provided as follows.

FIG. 1 illustrates a top view of a steering rack assembly in accordance with an embodiment of the present disclosure;

FIG. 2 illustrates a partial sectional view of the steering rack assembly shown in FIG. 1 taken along the line segment 2-2′;

FIG. 3 illustrates an exploded view of the steering rack assembly shown in FIG. 2;

FIG. 4 illustrates a partial sectional view of a steering rack assembly in accordance with another embodiment of the present disclosure;

FIG. 5 illustrates an exploded view of the steering rack assembly shown in FIG. 4; and

FIG. 6 illustrates a schematic diagram of an electric power steering system in accordance with an embodiment of the present disclosure.

### DETAILED DESCRIPTION

For the completeness of the description of the present disclosure, reference is made to the accompanying drawings and the various embodiments described below. Various features in the drawings are not drawn to scale and are provided for illustration purposes only. To provide full understanding of the present disclosure, various practical details will be explained in the following descriptions. However, a person with an ordinary skill in relevant art should realize that the present disclosure can be implemented without one or more of the practical details. Therefore, the present disclosure is not to be limited by these details.

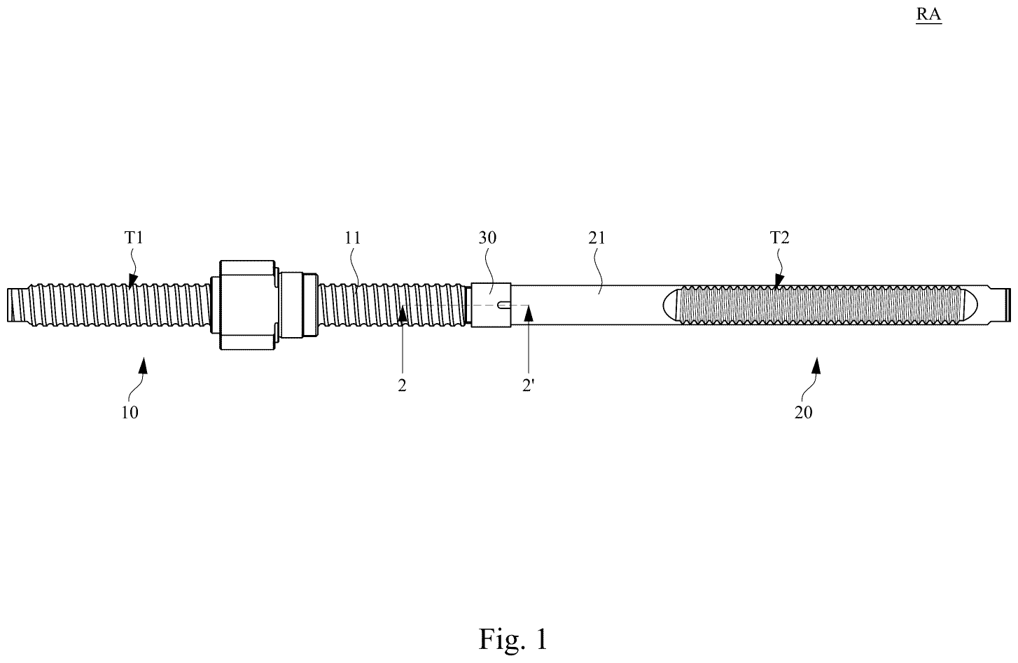

Reference is made to FIG. 1, which illustrates a top view of a steering rack assembly RA in accordance with an embodiment of the present disclosure. The steering rack assembly RA includes a first rod member 10, a second rod member 20 and a securing sleeve 30. The first rod member 10 is fixedly connected to the second rod member 20. The securing sleeve 30 is a hollow and generally cylindrical component. The securing sleeve 30 is fit over the first rod member 10 and the second rod member 20 and covers a portion where the first rod member 10 and the second rod member 20 are interconnected. The steering rack assembly RA can be incorporated as part of an electric power steering system. One of the first rod member 10 and the second rod member 20 is a screw device and the other is a rack. In the illustrated embodiment, the first rod member 10 is a screw device and the second rod member 20 is a rack. In the present embodiment, the screw device is a ball screw. In an alternative embodiment, the screw device can be a leadscrew. The screw device can be mechanically coupled to an electric motor of the electric power steering system. The electric motor can linearly move the steering rack assembly RA (e.g., move the steering rack assembly RA in a horizontal direction). The rack can be coupled to a steering wheel via a gear. The rack can be solid or hollow.

As shown in FIG. 1, the first rod member 10 includes a first main body 11. In the embodiment where the first rod member 10 is a screw device, the first main body 11 includes threads T1 to be coupled with the electric motor is provided. The second rod member 20 includes a second main body 21. In the embodiment where the second rod member 20 is a rack, the second main body 21 includes teeth T2 to be meshed with the gear are provided.

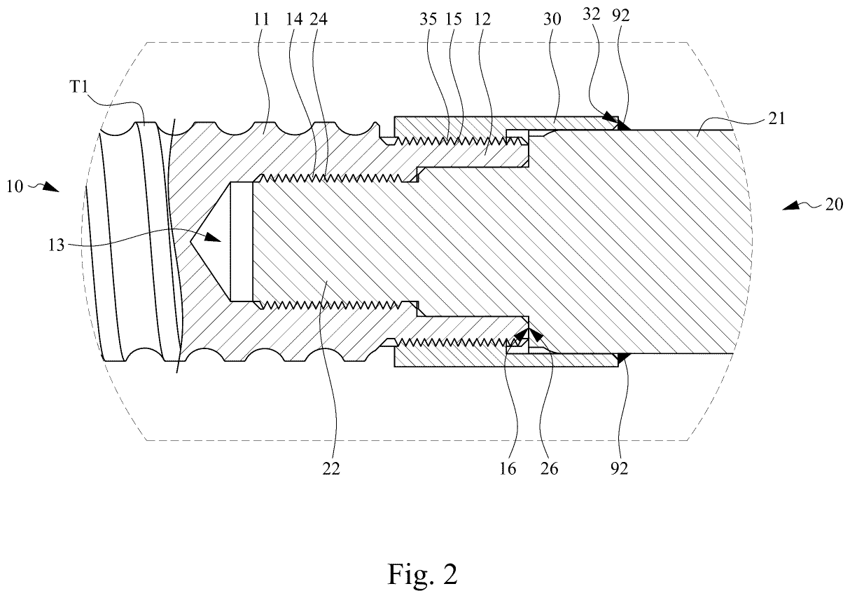

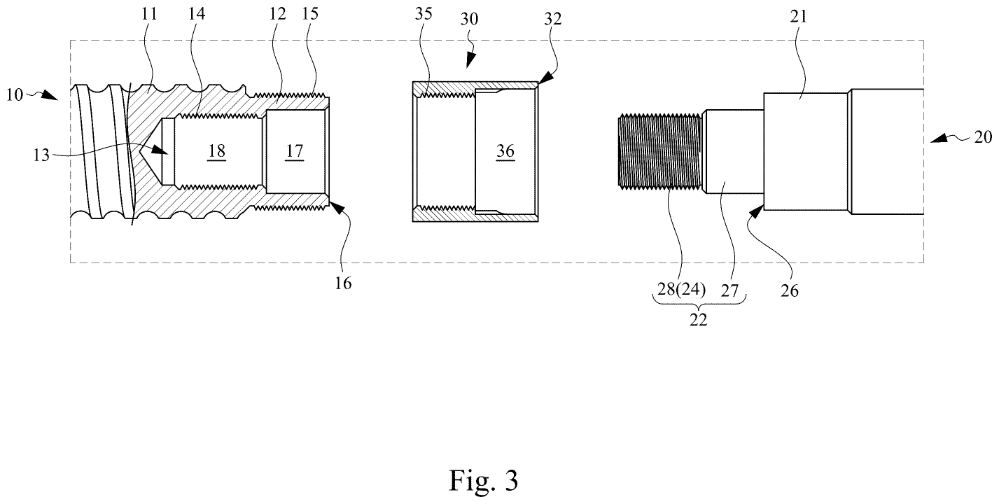

Reference is made to FIGS. 2 and 3. FIG. 2 illustrates a partial sectional view of the steering rack assembly RA shown in FIG. 1 taken along the line segment 2-2′, and FIG. 3 illustrates an exploded view of the steering rack assembly RA shown in FIG. 2. The first rod member 10 further includes a first terminal portion 12 connected to the first main body 11. The first terminal portion 12 is located on one end of the first main body 11 and is formed with a recess 13.

The second rod member 20 further includes a second terminal portion 22 connected to the second main body 21. The second terminal portion 22 is located on one end of the second main body 21 and is inserted into the recess 13 of the first rod member 10. The recess 13 of the first rod member 10 has a first internal thread 14 provided on an inner wall of the recess 13. The second terminal portion 22 of the second rod member 20 has a first external thread 24. The first external thread 24 is provided on an outer surface of the second terminal portion 22 and engages the first internal thread 14 of the recess 13. In some embodiments, the first internal thread 14 and the first external thread 24 each have a thread count of at least four to ensure that the first rod member 10 and the second rod member 20 are firmly joined.

As shown in FIGS. 2 and 3, the securing sleeve 30 is fixedly fit over the first terminal portion 12 of the first rod member 10 and the second rod member 20. In the present embodiment, the securing sleeve 30 is affixed to the first terminal portion 12 of the first rod member 10 via thread structure. Specifically, the first terminal portion 12 of the first rod member 10 has a second external thread 15. The second external thread 15 is provided on an outer surface of the first terminal portion 12 and surrounds the recess 13. The securing sleeve 30 has a second internal thread 35. The second internal thread 35 is provided on an inner circumferential surface of a central through hole 36 of the securing sleeve 30 and engages the second external thread 15 of the first rod member 10.

As shown in FIGS. 2 and 3, the securing sleeve 30 partially extends beyond an end surface 16 of the first terminal portion 12 of the first rod member 10 and is in tight contact with the second main body 21 of the second rod member 20. The securing sleeve 30 can be fixedly joined with the second rod member 20 additionally via a joint structure 92. In the present embodiment, the joint structure 92 includes a solder or welding joint (schematically shown as a black triangle in FIG. 2). The solder or welding joint is arranged along an end surface 32 of the securing sleeve 30 and is fixedly attached to the end surface 32 of the securing sleeve 30 and an outer surface of the second main body 21 of the second rod member 20. In other words, the solder or welding joint is located at a corner where the end surface 32 of the securing sleeve 30 and the outer surface of the second main body 21 of the second rod member 20 meet.

In some embodiment, a method of manufacturing the steering rack assembly RA includes the following steps (in order): (1) forming the first rod member 10, the second rod member 20 and the securing sleeve 30 using suitable manufacturing process for producing metal piece; (2) applying rotation to the first rod member 10 or the securing sleeve 30 to cause the second external thread 15 of the first rod member 10 to engage the second internal thread 35 of the securing sleeve 30, and temporarily keeping the securing sleeve 30 untightened; (3) applying rotation to the first rod member 10 or the second rod member 20 to cause the first internal thread 14 of the first rod member 10 to engage the first external thread 24 of the second rod member 20, until the end surface 16 of the first rod member 10 contacts a stopping surface 26 of the second rod member 20, resulting in the second terminal portion 22 of the second rod member 20 being inserted into the recess 13 of the first rod member 10; (4) applying a predetermined torque to the securing sleeve 30 to tighten the securing sleeve 30; and (5) performing soldering/welding at the corner where the end surface 32 of the securing sleeve 30 and the outer surface of the second main body 21 of the second rod member 20 meet (can be circumferential soldering/welding or partial soldering/welding). The stopping surface 26 of the second rod member 20 is a lateral surface of a stepped structure created between the second terminal portion 22 and the second main body 21 as a result of the second terminal portion 22 having a smaller maximum outer diameter than the second main body 21.

In some embodiments, pin joint, mortise and tenon joint or other suitable joining techniques can be implemented in place of the soldering/welding step described above. In other words, the securing sleeve 30 can be fixedly joined with the second rod member 20 via pin joint, mortise and tenon joint, or other suitable joint structures. In some embodiments, pin joint, mortise and tenon joint, or other suitable joining techniques can be implemented in addition to soldering/welding described above to improve the strength of the joint between the securing sleeve 30 and the second rod member 20.

As shown in FIGS. 2 and 3, in some embodiments, the recess 13 of the first rod member 10 has a threaded section 18 and a non-threaded section 17. The threaded section 18 has the first internal thread 14. The non-threaded section 17 is located between the threaded section 18 and an entrance of the recess 13. The non-threaded section 17 has a greater inner diameter than the threaded section 18. The non-threaded section 17 defines a first space that is generally cylindrical. The threaded section 18 defines a second space that is generally cylindrical. A central axis of the first space and a central axis of the second space are substantially collinear. By this arrangement, the second terminal portion 22 of the second rod member 20 can be guided into the recess 13 to mate with the first internal thread 14. In some embodiments, the second terminal portion 22 of the second rod member 20 has a first section 28 and a second section 27. The first section 28 has the first external thread 24 for engaging the first internal thread 14. The second section 27 is connected to the first section 28 and is inserted into the non-threaded section 17 of the recess 13. The second section 27 has a greater outer diameter than the first section 28. The outer diameter of the second section 27 is substantially the same as the inner diameter of the non-threaded section 17. The mating of the second section 27 and the non-threaded section 17 can provide guidance to the first section 28 having the first external thread 24 to precisely mate with the threaded section 18 of the recess 13.

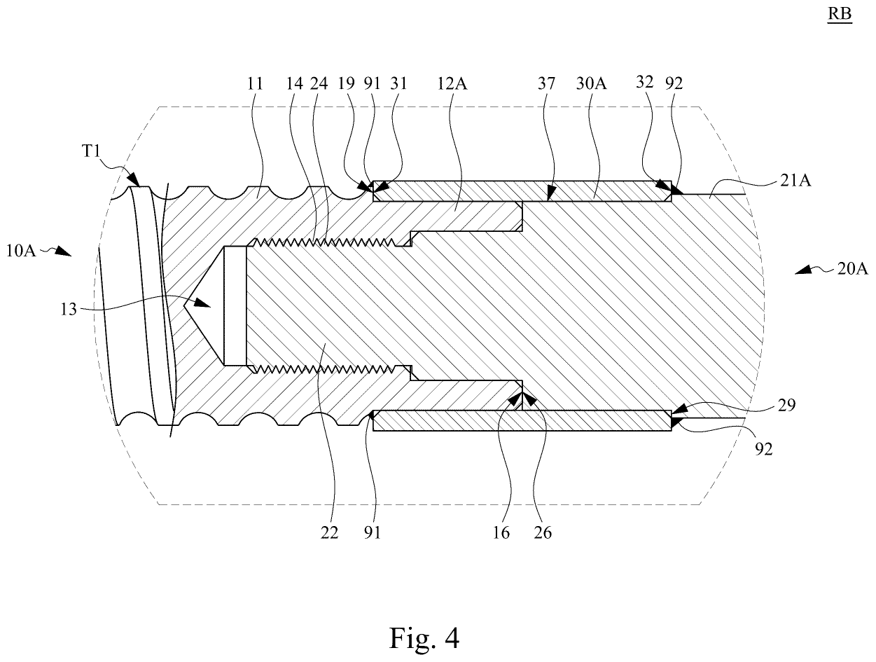

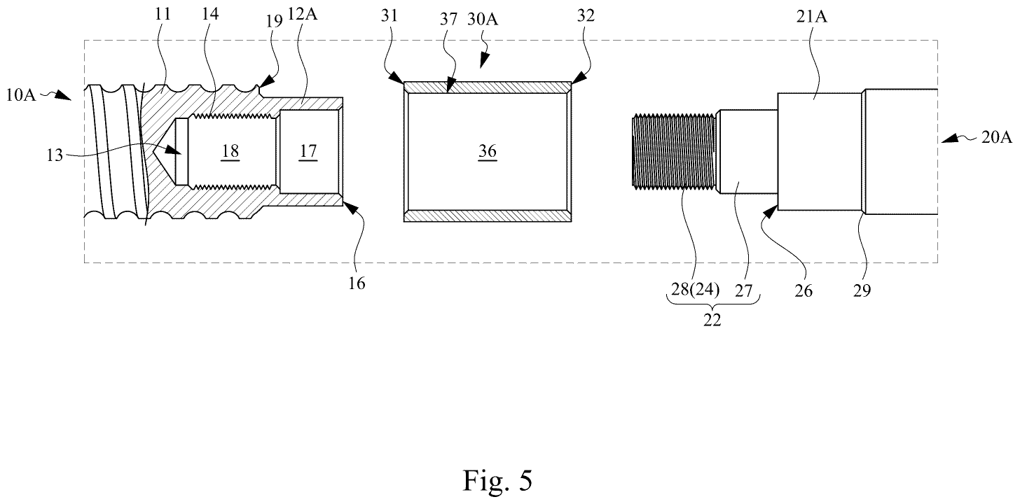

Reference is made to FIGS. 4 and 5. FIG. 4 illustrates a partial sectional view of a steering rack assembly RB in accordance with another embodiment of the present disclosure, and FIG. 5 illustrates an exploded view of the steering rack assembly RB shown in FIG. 4. The present embodiment differs from the previous embodiment in that: the securing sleeve 30A of the steering rack assembly RB has a smooth inner circumferential surface 37 (specifically, the inner circumferential surface 37 of the central through hole 36 of the securing sleeve 30A is overall smooth and thread-less), and correspondingly, an outer circumferential surface of the first terminal portion 12A of the first rod member 10A is also smooth and thread-less; the inner circumferential surface 37 of the securing sleeve 30A is in tight contact with the outer circumferential surface of the first terminal portion 12A of the first rod member 10A, and the securing sleeve 30A is fixedly joined with the first rod member 10A via at least one joint structure 91. Moreover, as with the previous embodiment, the inner circumferential surface 37 of the securing sleeve 30A is in tight contact with the outer surface of the second main body 21A of the second rod member 20A, and the securing sleeve 30A is fixedly joined with the second rod member 20A via at least one joint structure 92.

As shown in FIGS. 4 and 5, the securing sleeve 30A has another end surface 31 that is opposite to the end surface 32. The two end surfaces 31 and 32 are located on opposite sides of the securing sleeve 30A. In the illustrated embodiment, the joint structure 91 includes at least one solder or welding joint (schematically shown as a black triangle in FIG. 4). The solder or welding joint is arranged along the end surface 31 of the securing sleeve 30A and is fixedly attached to the end surface 31 of the securing sleeve 30A and an outer surface of the first rod member 10A. In other words, the solder or welding joint (i.e., the joint structure 91) is located at a corner where the end surface 31 of the securing sleeve 30A and the outer surface of the first rod member 10A meet. In other embodiments, the joint structure 91 can include pin joint, mortise and tenon joint, other suitable joint structures or any combination thereof.

As shown in FIGS. 4 and 5, in some embodiments, the first rod member 10A and the second rod member 20A include a first stopper structure 19 and a second stopper structure 29, respectively. The securing sleeve 30A is clamped between the first stopper structure 19 and the second stopper structure 29. In some embodiments, the first terminal portion 12A of the first rod member 10A has a smaller outer diameter than the first main body 11 and thereby creates a first stepped structure that acts as the first stopper structure 19. The second main body 21A of the second rod member 20A has two sections. The two sections have different outer diameters and thereby create a second stepped structure that acts as the second stopper structure 29.

In some embodiment, a method of manufacturing the steering rack assembly RB includes the following steps (in order): (1) forming the first rod member 10A, the second rod member 20A and the securing sleeve 30A using suitable manufacturing process for producing metal piece; (2) fitting the securing sleeve 30A on the first terminal portion 12A of the first rod member 10A; (3) applying rotation to the first rod member 10A or the second rod member 20A to cause the first internal thread 14 of the first rod member 10A to engage the first external thread 24 of the second rod member 20A, until the end surface 16 of the first rod member 10A contacts the stopping surface 26 of the second rod member 20A, resulting in the second terminal portion 22 of the second rod member 20A being inserted into the recess 13 of the first rod member 10A and the securing sleeve 30A being clamped between the first stopper structure 19 of the first rod member 10A and the second stopper structure 29 of the second rod member 20A; and (4) performing soldering/welding at a first location and a second location, the first location is at the corner where the end surface 31 of the securing sleeve 30A and the outer surface of the first rod member 10A meet (e.g., the first location is next to the first stopper structure 19), and the second location is at the corner where the end surface 32 of the securing sleeve 30A and the outer surface of the second main body 21A of the second rod member 20A meet (e.g., the second location is next to the second stopper structure 29).

In some embodiments, pin joint, mortise and tenon joint, or other suitable joining techniques can be implemented in place of the soldering/welding step described above. In other words, the securing sleeve 30A can be fixedly joined with the first rod member 10A and the second rod member 20A via pin joint, mortise and tenon joint, or other suitable joint structures. In some embodiments, pin joint, mortise and tenon joint, or other suitable joining techniques can be implemented in addition to soldering/welding described above to improve the strength of the joint between the securing sleeve 30A and the first rod member 10A and/or the joint between the securing sleeve 30A and the second rod member 20A.

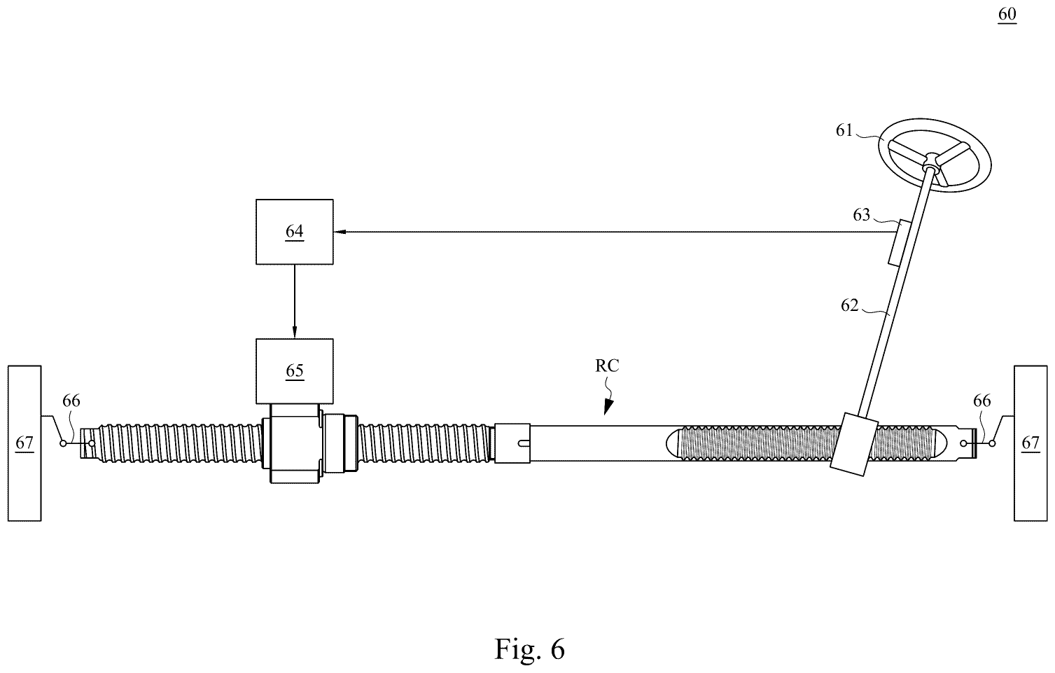

Reference is made to FIG. 6, which illustrates a schematic diagram of an electric power steering system 60 in accordance with an embodiment of the present disclosure. The electric power steering system 60 includes a steering rack assembly RC, which may be the steering rack assembly RA or RB described above. The electric power steering system 60 may further include a steering wheel 61, a steering column 62, a pair of tie rods 66, and a pair of wheels 67. The steering wheel 61 is coupled to the rack of the steering rack assembly RC via the steering column 62. The steering column 62 includes a gear meshing with the teeth of the rack. The two ends of the steering rack assembly RC are each coupled to a respective wheel 67 via one of the tie rods 66. The steering rack assembly RC can move horizontally and provide a moving force, which is transmitted to the wheels 67 by the tie rods 66 and results in the wheels 67 being turned.

As shown in FIG. 6, the electric power steering system 60 may further include at least one sensor 63, a controller 64, and an electric motor 65. The at least one sensor 63 is coupled to the steering column 62. The at least one sensor 63 may include a rotation angle sensor configured to provide at least one sensing signal indicative of a rotation angle of the steering column 62. The at least one sensor 63 may include a torque sensor configured to provide at least one sensing signal indicative of a torque acting on the steering column 62. The controller 64 is communicably connected to the sensor 63 and the electric motor 65. The controller 64 is configured to receive the sensing signal from the sensor 63 and provide a control signal to the electric motor 65 based on the received sensing signal. The electric motor 65 is mechanically coupled to the screw device of the steering rack assembly RC and is configured to linearly move the steering rack assembly RC based on the control signal received from the controller 64. In some embodiments, the screw device is a ball screw. The ball screw may include a threaded shaft and a ball nut disposed on the threaded shaft. The electric motor 65 can be mechanically coupled to the ball nut and can rotate the ball nut. Rotation of the ball nut causes the threaded shaft to move linearly in the horizontal direction. In some embodiments, the controller 64 is an electronic control unit (ECU) of a vehicle.

In sum, the steering rack assembly of the present disclosure includes a first rod member and a second rod member interconnected via internal and external threads, and further includes a securing sleeve fixedly fit over the first rod member and the second rod member and covering the connection interface between the first rod member and the second rod member. The securing sleeve can not only facilitate affixing the first rod member and the second rod member to each other, but also improve the mechanical strength of the connection interface between the first rod member and the second rod member to prevent rupture of the steering rack assembly. Furthermore, the securing sleeve can be fixedly joined with the first rod member and/or the second rod member additionally via a joint structure (e.g., solder/welding joint, pin joint, mortise and tenon joint, or other suitable joint structures), such that the first rod member, the second rod member and the securing sleeve can be more tightly combined. Unlike conventional steering rack which is typically unitary and therefore the entire steering rack needs to be design and develop independently for each vehicle manufacturer to meet the different requirements of different vehicle manufacturers, the rack part and the screw part (e.g., ball screw) of the steering rack assembly of the present disclosure are separated. The screw part can be made into a standard product. The rack part can be designed according to the requirements of each vehicle manufacturer and then combined with the screw part. By this arrangement, design and manufacturing of the steering rack can be simplified. Meanwhile, since the various components of the steering rack assembly of the present disclosure are tightly combined and have great strength, the mechanical properties of the steering rack assembly can meet the requirements of steering systems.

Although the present disclosure has been described by way of the exemplary embodiments above, the present disclosure is not to be limited to those embodiments. Any person skilled in the art can make various changes and modifications without departing from the spirit and the scope of the present disclosure. Therefore, the protective scope of the present disclosure shall be the scope of the claims as attached.

What is claimed is:

1. A steering rack assembly, comprising:
a first rod member comprising a first terminal portion, the first terminal portion being formed with a recess, the recess having a first internal thread;
a second rod member comprising a second terminal portion, the second terminal portion being inserted into the recess of the first rod member and having a first external thread, the first external thread engaging the first internal thread, wherein one of the first rod member and the second rod member is a screw device and the other is a rack; and
a securing sleeve fixedly fit over the first terminal portion of the first rod member and the second rod member.

2. The steering rack assembly of claim 1, wherein the first terminal portion of the first rod member has a second external thread surrounding the recess, the securing sleeve has a second internal thread engaging the second external thread, and the securing sleeve is fixedly joined with the second rod member via a joint structure.

3. The steering rack assembly of claim 2, wherein the joint structure comprises a solder or welding joint, the solder or welding joint is arranged along an end surface of the securing sleeve and is fixedly attached to the end surface of the securing sleeve and an outer surface of the second rod member.

4. The steering rack assembly of claim 1, wherein the recess of the first rod member has a threaded section and a non-threaded section, the threaded section has the first internal thread, the non-threaded section is located between the threaded section and an entrance of the recess, and the non-threaded section has a greater inner diameter than the threaded section.

5. The steering rack assembly of claim 4, wherein the second terminal portion of the second rod member has a first section and a second section, the first section has the first external thread, the second section is inserted into the non-threaded section of the recess, and the second section has a greater outer diameter than the first section.

6. The steering rack assembly of claim 1, wherein the securing sleeve has a smooth inner circumferential surface that is in tight contact with the first terminal portion of the first rod member and the second rod member, and the securing sleeve is fixedly joined with the first rod member and the second rod member via at least one joint structure.

7. The steering rack assembly of claim 6, wherein the securing sleeve has two opposite end surfaces, the at least one joint structure comprises at least one solder or welding joint, the at least one solder or welding joint is arranged along the two opposite end surfaces of the securing sleeve and is fixedly attached to the two opposite end surfaces of the securing sleeve, an outer surface of the first rod member, and an outer surface of the second rod member.

8. The steering rack assembly of claim 6, wherein the first rod member and the second rod member comprise a first stopper structure and a second stopper structure, respectively, and the securing sleeve is clamped between the first stopper structure and the second stopper structure.

9. The steering rack assembly of claim 8, wherein the first rod member further comprises a first main body connected to the first terminal portion, the first terminal portion has a smaller outer diameter than the first main body and thereby creates a first stepped structure that acts as the first stopper structure, the second rod member further comprises a second main body with two sections, the two sections have different outer diameters and thereby create a second stepped structure that acts as the second stopper structure.

10. The steering rack assembly of claim 1, wherein the screw device is a ball screw.

11. An electric power steering system, comprising:
a steering rack assembly, comprising:
a first rod member comprising a first terminal portion, the first terminal portion being formed with a recess, the recess having a first internal thread;
a second rod member comprising a second terminal portion, the second terminal portion being inserted into the recess of the first rod member and having a first external thread, the first external thread engaging the first internal thread, wherein one of the first rod member and the second rod member is a screw device and the other is a rack; and
a securing sleeve fixedly fit over the first terminal portion of the first rod member and the second rod member; and
an electric motor mechanically coupled to the screw device and configured to linearly move the steering rack assembly.

12. The system of claim 11, wherein the first terminal portion of the first rod member has a second external thread surrounding the recess, the securing sleeve has a second internal thread engaging the second external thread, and the securing sleeve is fixedly joined with the second rod member via a joint structure.

13. The system of claim 12, wherein the joint structure comprises a solder or welding joint, the solder or welding joint is arranged along an end surface of the securing sleeve and is fixedly attached to the end surface of the securing sleeve and an outer surface of the second rod member.

14. The system of claim 11, wherein the recess of the first rod member has a threaded section and a non-threaded section, the threaded section has the first internal thread, the non-threaded section is located between the threaded section and an entrance of the recess, and the non-threaded section has a greater inner diameter than the threaded section.

15. The system of claim 14, wherein the second terminal portion of the second rod member has a first section and a second section, the first section has the first external thread, the second section is inserted into the non-threaded section of the recess, and the second section has a greater outer diameter than the first section.

16. The system of claim 11, wherein the securing sleeve has a smooth inner circumferential surface that is in tight contact with the first terminal portion of the first rod member and the second rod member, and the securing sleeve is fixedly joined with the first rod member and the second rod member via at least one joint structure.

17. The system of claim 16, wherein the securing sleeve has two opposite end surfaces, the at least one joint structure comprises at least one solder or welding joint, the at least one solder or welding joint is arranged along the two opposite end surfaces of the securing sleeve and is fixedly attached to the two opposite end surfaces of the securing sleeve, an outer surface of the first rod member, and an outer surface of the second rod member.

18. The system of claim 16, wherein the first rod member and the second rod member comprise a first stopper structure and a second stopper structure, respectively, and the securing sleeve is clamped between the first stopper structure and the second stopper structure.

19. The system of claim 18, wherein the first rod member further comprises a first main body connected to the first terminal portion, the first terminal portion has a smaller outer diameter than the first main body and thereby creates a first stepped structure that acts as the first stopper structure, the second rod member further comprises a second main body with two sections, the two sections have different outer diameters and thereby create a second stepped structure that acts as the second stopper structure.

20. The system of claim 11, wherein the screw device is a ball screw.
